(19) United States
(12) Patent Application Publication
(10) Pub. No.: US 2012/0039477 A1
(43) Pub. Date: Feb. 16, 2012

(54) AUDIO SIGNAL SYNTHESIZING

(75) Inventors: Erik Gosuinus Petrus Schijers, Eindhoven (NL); Arnoldus Werner Johannes Oomen, Eindhoven (NL); Fransiscus Marinus Jozephus De Bont, Eindhoven (NL); Mykola Ostrovskyy, Eindhoven (NL); Adriaan Johannes Rijnberg, Eindhoven (NL); Jeroen Gerardus Henricus Koppens, Eindhoven (NL)

(73) Assignee: KONINKLIJKE PHILIPS ELECTRONICS N.V., EINDHOVEN (NL)

(21) Appl. No.: 13/265,423

(22) PCT Filed: Apr. 14, 2010
(86) PCT No.: PCT/IB2010/051622

§ 371 Date: Oct. 20, 2011

(30) Foreign Application Priority Data
Apr. 21, 2009 (EP) 09158323.7

(51) Int. Cl. H04R 5/00

(52) U.S. Cl. 381/22

(57) ABSTRACT

An audio synthesizing apparatus receives an encoded signal comprising a downmix signal and parametric extension data for expanding the downmix signal to a multi-sound source signal. A decomposition processor (205) performs a signal decomposition of the downmix signal to generate at least a first signal component and a second signal component, where the second signal component is at least partially decorrelated with the first signal component. A position processor (207) determines a first spatial position indication for the first signal component in response to the parametric extension data and a binaural processor (211) synthesizes the first signal component based on the first spatial position indication and the second signal component to originate from a different direction. The invention may provide improved spatial experience from e.g. headphones by using a direct synthesis of a main directional signal from the appropriate position rather than as a combination of signals from virtual loudspeaker positions.

### FIELD OF THE INVENTION

The invention relates to audio signal synthesizing and in particular, but not exclusively, to synthesizing of spatial surround sound audio for headphone reproduction.

### BACKGROUND OF THE INVENTION

Digital encoding of various source signals has become increasingly important over the last decades as digital signal representation and communication increasingly has replaced analogue representation and communication. For example, encoding standards for efficiently encoding music or other audio signals have been developed.

The most popular loudspeaker reproduction system is based on two-channel stereophony wherein two loudspeakers at predetermined positions are typically employed. In such systems, a sound space is generated based on two channels being radiated from the two loudspeaker positions, and the original stereo signals are typically generated such that a desired sound stage is reproduced when the loudspeakers are situated close to their predetermined positions relative to the listener. In such cases, the user may be considered to be in the sweet spot.

Stereo signals are often generated using amplitude panning. In such a technique, individual sound objects may be positioned in the sound stage between the speakers by adjusting the amplitude of the corresponding signal components in the left and right channel respectively. Thus, for a central position, each channel is fed the signal component in phase and attenuated by 3 dB. For positions towards the left loudspeaker, the amplitude of the signal in the left channel may be increased and the amplitude in the right channel may be decreased correspondingly and vice versa for positions towards the right speaker.

However, although such stereo reproduction may provide a spatial experience, it tends to be suboptimal. For example, the positions of sounds are limited to being between the two loudspeakers, the optimal spatial sound experience is limited to a small listening area (a small sweet spot), a specific head orientation is required (towards the midway point between the speakers), a spectral coloration may occur due to varying path length differences from the speakers to the listeners ears, the sound source localization cues provided by the amplitude panning approach are only a crude approximation of the localization cues that would correspond to a sound source at the desired position, etc.

Compared to a loudspeaker playback scenario, stereo audio content reproduced via headphones is perceived to originate inside the listener's head. The absence of an effect of the acoustical path from an external sound source to the listener's ears causes the spatial image to sound unnatural.

In order to overcome this and to provide an improved spatial experience from headphones, binaural processing has been introduced to generate suitable signals for each ear piece of a headphone. Specifically, the signal to the left earpiece/headphone is filtered by two filters estimated to correspond to the acoustic transfer functions from the left and respectively right speakers to the user's left ear if the signal was received in a conventional stereo set-up (including any influences due to the shape of the head and the ears). Also, two filters are applied to the signal to the right earpiece/headphone to correspond to the acoustic transfer functions from the left and respectively right speakers to the user's right ear.

The filters thus represent perceptual transfer functions that model the influence of the human head, and possibly other objects, on the signal. A well-known type of spatial perceptual transfer function are the so-called Head-Related Transfer Functions (HRTFs) which describe the transfer from a certain sound source position to the eardrums by means of impulse responses. An alternative type of spatial perceptual transfer functions, which also takes into account reflections caused by the walls, ceiling and floor of a room, are the Binaural Room Impulse Response (BRIRs). In order to synthesize a sound from a specific position, the corresponding signal is filtered by two HRTFs (or BRIRs) namely the ones representing an acoustic transfer function from the estimated position to the left and right ears respectively. Such two HRTFs (or BRIRs) are typically referred to as an HRTF pair (or BRIR pair).

The binaural processing can provide an improved spatial experience and can in particular create an ‘out-of-head’ 3D effect.

Thus, traditional binaural stereo processing is based on an assumption of a virtual position of the individual stereo speakers. It then seeks to model the acoustic transfer functions that are experienced by the signal components from these loudspeakers. However, such an approach tends to introduce some degradations and specifically suffer from many of the disadvantages of a conventional stereo system using loudspeakers.

Indeed, headphone audio reproduction based on a fixed set of virtual speakers tends to suffer from drawbacks that are inherently introduced by a real set of fixed loudspeakers as previously discussed. One specific drawback is that localization cues tend to be crude approximations of the actual localization cues of a sound source at a desired position, which results in a degraded spatial image. Another drawback is that amplitude panning only works in a left-right direction, and not in any other direction.

Binaural processing may be extended to multi-channel audio system with more than two channels. For example, binaural processing can be used for a surround sound system comprising e.g. five or seven spatial channels. In such examples, an HRTF is determined for each speaker position to each of the two ears of the user. Thus, two HRTFs are used for each speaker/channel resulting in a large number of signal components corresponding to different acoustic transfer functions being simulated. This tends to lead to a degradation of the perceived quality. For example, as HRTF functions are only approximations of the correct transfer functions that would be perceived, the large number of HRTFs being combined tend to introduce inaccuracies that can be perceived by a user. Thus, the disadvantages tend to increase for multi-channel systems. Also, the approach has a high degree of complexity and has a high computational resource usage. Indeed, in order to convert e.g. a 5.1 or even 7.1 surround signal into a binaural signal, a very substantial amount of filtering is required.

However, recently it has been proposed that the quality of virtual surround rendering of stereo content can be significantly improved by so-called phantom materialization. Specifically, such an approach has been proposed in European patent application EP 07117830.5 and the article “Phantom Materialization: A Novel Method to Enhance Stereo Audio Reproduction on Headphones” by J. Breebaart, E. Schuijers, IEEE Transactions on Audio, Speech, and Language Processing, Vol. 16, No. 8, pp. 1503-1511, November 2008.

In the approach, a virtual stereo signal is not generated by assuming two sound sources originating from the virtual loudspeaker positions, but rather the sound signal is decomposed into a directional signal component and an indirect/decorrelated signal component. This decomposition may specifically be for both a suitable time and frequency range. The direct component is then synthesized by simulating a virtual loudspeaker at the phantom position. The indirect component is synthesized by simulating virtual loudspeakers at fixed positions (typically corresponding to a nominal position for surround speakers).

For example, if a stereo signal comprises a single sound component that is panned to, say, 10° towards the right, the stereo signal may comprise a signal in the right channel that is around twice as loud as signal in the left channel. In traditional binaural processing, this sound component will thus be represented by a component from the left channel filtered by the HRTF from the left speaker to the left ear, a component from the left channel filtered by the HRTF from the left speaker to the right ear, a component from the right channel filtered by the HRTF from the right speaker to the left ear, and a component from the right channel filtered by the HRTF from the right speaker to the right ear. In contrast, in the phantom materialization approach, the main component may be generated as a sum of the signal components corresponding to the sound component and the direction of this main component may then be estimated (i.e. 10° towards the right). The phantom materialization approach furthermore generates one or more diffuse or decorrelated signals which represent the residual signal components after the common component of the two stereo channels (the main component) has been subtracted. Thus, the residual signal may represent the sound ambiance such as e.g. the sound originating from reflections in the room, reverberations, ambience noise etc. The phantom materialization approach then proceeds to synthesize the main component to originate directly from the estimated position, i.e. from 10° towards the right. Thus, the main component is synthesized using only two HRTFs, namely the ones representing an acoustic transfer function from the estimated position to the left and right ears respectively. The diffuse ambiance signal may then be synthesized to originate from other positions.

The phantom materialization approach has the advantage that it does not impose the limitations of a speaker setup onto the virtual rendering scene and accordingly it provides a much improved spatial experience. In particular, a much clearer and well defined positioning of sounds in the sound stage perceived by the listener can typically be achieved.

However, a problem with the phantom materialization approach is that it is limited to stereo systems. Indeed, EP 07117830.5 explicitly states that if more than two channels are present, then the phantom materialization approach should be applied individually and separately to each stereo pair of channels (corresponding to each loudspeaker pair). However, such an approach may not only be complex and resource demanding but may also often result in degraded performance.

Hence, an improved system would be advantageous and in particular a system allowing increased flexibility, reduced complexity, reduced resource requirements, improved suitability for multi-channel systems with more than two channels, improved quality, an improved spatial user experience and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for synthesizing a multi-sound source signal, the apparatus comprising: a unit for receiving an encoded signal representing the multi-sound source signal, the encoded signal comprising a downmix signal for the multi-sound source signal and parametric extension data for expanding the downmix signal to the multi-sound source signal; a decomposition unit for performing a signal decomposition of the downmix signal to generate at least a first signal component and a second signal component, the second signal component being at least partially decorrelated with the first signal component; a position unit for determining a first spatial position indication for the first signal component in response to the parametric extension data; a first synthesizing unit for synthesizing the first signal component based on the first spatial position indication; and a second synthesizing unit for synthesizing the second signal component to originate from a different direction than the first signal component.

The invention may provide improved audio performance and/or facilitated operation in many scenarios.

Specifically, the invention may in many scenarios provide an improved and more well-defined spatial experience. In particular, an improved surround sound experience may be provided with a more well-defined perception of the position of individual sound components in the sound stage. The invention may be suitable to multi-channel systems with more than two channels. Furthermore, the invention may allow a facilitated and improved surround sound experience and may allow a high degree of compatibility with existing multi-channel (N>2) encoding standards, such as for example the MPEG Surround standard.

The parametric extension data may specifically be parametric spatial extension data. The parametric extension data may e.g. characterise an upmixing from the down-mix to a plurality (more than two) spatial sound channels.

The second signal component may e.g. be synthesized to originate from one or more fixed positions. Each sound source may correspond to a channel of a multi-channel signal. The multi-sound source signal may specifically be a multi-channel signal with more than two channels.

The first signal component may typically correspond to a main directional signal component. The second signal component may correspond to a diffuse signal component. For example, the second signal component may predominantly represent ambiance audio effects, such as e.g. reverberations and room reflections. The first signal component may specifically correspond to a component approximating a phantom source as would be obtained with an amplitude panning technique used in a classical loudspeaker system.

It will be appreciated that in some embodiments, the decomposition may further generate additional signal components, which may e.g. be further directional signals and/or may be diffuse signals. In particular, a third signal component may be generated to be at least partially decorrelated with the first signal component. In such systems, the second signal component may be synthesized to predominantly originate from the right side whereas the third signal component may be synthesized to predominantly originate from the left side (or vice versa).

The first spatial position indication may for example be an indication of a three dimensional position, a direction, an angle and/or a distance e.g. for the phantom source corresponding to the first signal component.

In accordance with an optional feature of the invention, the apparatus further comprises a unit for dividing the downmix into time-interval frequency-band blocks and being arranged to process each time-interval frequency-band block individually.

This may provide improved performance and/or facilitated operation and/or reduced complexity in many embodiments. Specifically, the feature may allow improved compatibility with many existing multi-channel coding systems and may simplify the required processing. Furthermore, the feature may provide improved sound source positioning for a sound signal wherein the downmix comprises contributions from a plurality of sound components at different locations. In particular, the approach may exploit the fact that for such scenarios, each sound component is often dominant in a limited number of time-interval frequency-band blocks and accordingly the approach may allow each sound component to automatically be positioned at the desired location.

In accordance with an optional feature of the invention, the first synthesizing unit is arranged to apply a parametric Head Related Transfer Function to time-interval frequency-band blocks of the first signal component, the parametric Head Related Transfer Function corresponding to a position represented by the first spatial position indication and comprising a parameter value set for each time interval frequency band block.

This may provide improved performance and/or facilitated operation and/or reduced complexity in many embodiments. Specifically, the feature may allow improved compatibility with many existing multi-channel coding systems and may simplify the required processing. A substantially reduced computational resource usage can typically be achieved.

The parameter set may for example comprise a power and angle parameter or a complex number to be applied to the signal value of each time interval frequency band block.

In accordance with an optional feature of the invention, the multi-sound source signal is a spatial multi-channel signal.

The invention may allow improved and/or facilitated synthesis of multi-channel signals (e.g. with more than two channels).

In accordance with an optional feature of the invention, the position unit is arranged to determine the first spatial position indication in response to assumed speakers positions for channels of the multi-channel signal and an upmix parameters of the parametric extension data, the upmix parameters being indicative of an upmix of the downmix to result in the multi-channel signal.

This may provide improved performance and/or facilitated operation and/or reduced complexity in many embodiments. In particular, it allows for a particularly practical implementation which results in an accurate estimation of the position thus resulting in a high quality spatial experience.

In accordance with an optional feature of the invention, the parametric extension data describes a transformation from the downmix signal to the channels of the multi-channel signal and the position unit is arranged to determine an angular direction for the first spatial position indication in response to a combination of weights and angles for the assumed speakers positions for channels of the multi-channel signal, each weight for a channel being dependent on a gain of the transformation from the down mix signal to the channel.

This may provide a particularly advantageous determination of a position estimate for the first signal. In particular, it may allow an accurate estimation based on relatively low complexity processing and may in many embodiments be particularly suitable for existing multi-channel/source encoding standards.

In some embodiments, the apparatus may comprise means for determining an angular direction for a second spatial position indication for the second signal component in response to a combination of weights and angles for the assumed speaker positions, each weight for a channel being dependent on an amplitude gain of the transformation from the down mix signal to the channel.

In accordance with an optional feature of the invention, the transformation includes a first sub-transformation including a signal decorrelation function and a second sub-transformation not including a signal decorrelation function, and wherein the determination of the first spatial position indication does not consider the first sub-transformation.

This may provide a particularly advantageous determination of a position estimate for the first signal. In particular, it may allow an accurate estimation based on relatively low complexity processing and may in many embodiments be particularly suitable for existing multi-channel/source encoding standards.

The first sub-transformation may specifically correspond to the processing for “wet” signals of a parametric spatial decoding operation (such as an MPEG surround decoding) and the second sub-transformation may correspond to the processing for “dry” signals.

In some embodiments, the apparatus may be arranged to determine a second spatial position indication for the second signal component in response to the transformation and without considering the second sub-transformation.

In accordance with an optional feature of the invention, the apparatus further comprises a second position unit arranged to generate a second spatial position indication for the second signal component in response to the parametric extension data; and the second synthesizing unit is arranged to synthesize the second signal component based on the second spatial position indication.

This may in many embodiments provide improved spatial experience and may in particular improve the perception of the diffuse signal components.

In accordance with an optional feature of the invention, the downmix signal is a mono signal and the decomposition unit is arranged to generate the first signal component to correspond to the mono signal and the second signal component to correspond to a decorrelated signal for the mono-signal.

The invention may provide a high quality spatial experience even for encoding schemes employing a simple mono downmix.

In accordance with an optional feature of the invention, the first signal component is a main directional signal component and the second signal component is a diffuse signal component for the down-mix signal.

The invention may provide an improved and more well-defined spatial experience by separating and differently synthesizing directional and diffuse signals.

In accordance with an optional feature of the invention, the second signal component corresponds to a residual signal resulting from compensating the downmix for the first signal component.

This may provide a particularly advantageous performance in many embodiments. The compensation may for example be by subtracting the first signal component from one or more channels of the downmix.

In accordance with an optional feature of the invention, the decomposition unit is arranged to determine the first signal component in response to a function combining signals for a plurality of channels of the downmix, the function being dependent on at least one parameter and wherein the decomposition unit is further arranged to determine the at least one parameter to maximise a power measure for the first signal component.

This may provide a particularly advantageous performance in many embodiments. In particular, it may provide a highly effective approach for decomposing the downmix signal into a component corresponding to (at least) a main directional signal and a component corresponding to a diffuse ambient signal.

In accordance with an optional feature of the invention, each source of the multi-source signal is a sound object.

The invention may allow an improved synthesis and rendering of individual or a plurality of sound objects. The sound objects may for example be multi-channel sound objects such as stereo sound objects.

In accordance with an optional feature of the invention, the first spatial position indication includes a distance indication for the first signal component and the first synthesizing unit is arranged to synthesize the first signal component in response to the distance indication.

This may improve the spatial perception and spatial experience for a listener.

According to an aspect of the invention there is provided a method of synthesizing a multi-sound source signal, the method comprising: receiving an encoded signal representing the multi-sound source signal, the encoded signal comprising a downmix signal for the multi-sound source signal and parametric extension data for expanding the downmix signal to the multi-sound source signal; performing a signal decomposition of the downmix signal to generate at least a first signal component and a second signal component, the second signal component being at least partially decorrelated with the first signal component; determining a first spatial position indication for the first signal component in response to the parametric extension data; synthesizing the first signal component based on the first spatial position indication; and synthesizing the second signal component to originate from a different direction than the first signal component.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of elements of an MPEG Surround audio codec;

FIG. 2 illustrates an example of elements of an audio synthesizer in accordance with some embodiments of the invention;

FIG. 3 illustrates an example of elements of generating a decorrelated signal for a mono signal; and

FIG. 4 illustrates an example of elements of an MPEG Surround audio upmixing.

### DETAILED DESCRIPTION OF SOME EMBODIMENTS OF THE INVENTION

The following description focuses on embodiments of the invention applicable to a system using MPEG Surround encoded signals but it will be appreciated that the invention is not limited to this application but may be applied to many other encoding mechanisms.

MPEG Surround is one of the major advances in multi-channel audio coding recently standardized by the Motion Pictures Expert Group in the standard ISO/IEC 23003-1, MPEG Surround. MPEG Surround is a multi-channel audio coding tool that allows existing mono- or stereo-based coders to be extended to more channels.

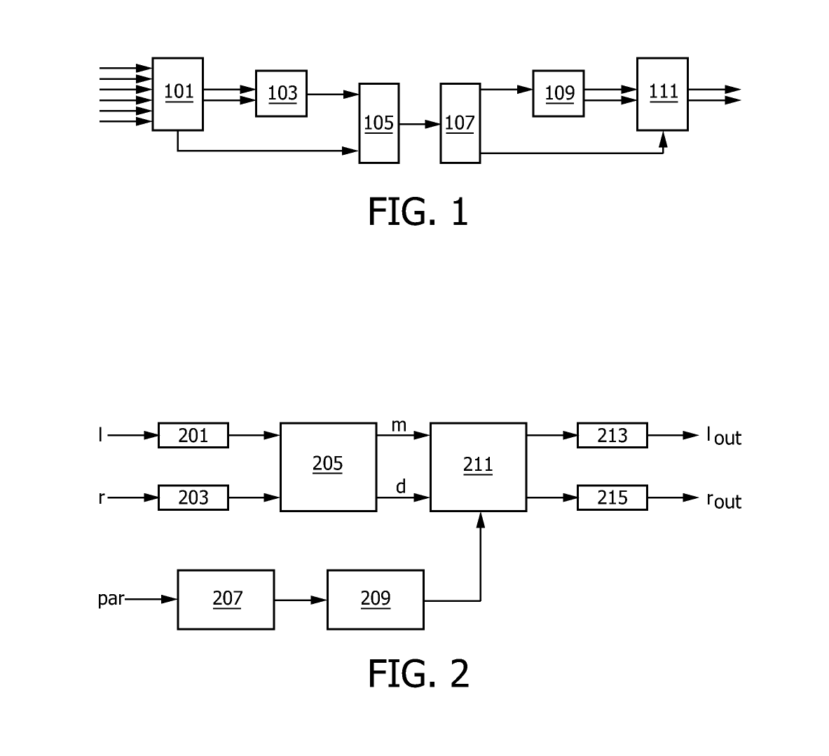

FIG. 1 illustrates an example of a block diagram of a stereo core coder extended with MPEG Surround. First the MPEG Surround encoder creates a stereo downmix from the multi-channel input signal in a downmixer 101. Then spatial parameters are estimated from the multi-channel input signal by the downmixer 101. These parameters are encoded into the MPEG Surround bit-stream. The stereo downmix is coded into a bit-stream using a core encoder 103, such as e.g. an HE-AAC core encoder. The resulting core coder bit-stream and the spatial parameter bit-stream are merged in a multiplexer 105 to create the overall bit-stream. Typically the spatial bit-stream is contained in the ancillary data portion of the core coder bit-stream.

Thus, the encoded signal is represented by a mono or stereo downmix signal which is encoded separately. This downmix signal can be decoded and synthesized in legacy decoders to provide a mono or stereo output signal. Furthermore, the encoded signal includes parametric extension data comprising spatial parameters for upmixing the downmix signal to the encoded multi-channel signal. Thus, a suitably equipped decoder can generate a multi channel surround signal by extracting the spatial parameters and upmixing the downmix signal based on these spatial parameters. The spatial parameters may for example include interchannel level differences, interchannel correlation coefficients, interchannel phase differences, interchannel time differences etc. as will be well known to the person skilled in the art.

In more detail, the decoder of FIG. 1 first extracts the core data (the encoding data for the downmix) and the parametric extension data (the spatial parameters) in a demultiplexer 107. The data representing the down-mix signal, namely the core bit-stream, is decoded in a decoder unit 109 in order to reproduce the stereo downmix. This downmix together with the data representing the spatial parameters is then fed to an MPEG Surround decoding unit 111 which first generates the spatial parameters by decoding the corresponding data of the bit stream. The spatial parameters are then used to upmix the stereo downmix in order to obtain the multi-channel output signal.

In the example of FIG. 1 the MPEG Surround decoding unit 111 includes a binaural processor which processes the multi-channels so as to provide a two channel spatial surround signal suitable for listening to with headphones. Thus, for each of the multiple output channels, the binaural processor applies an HRTF to respectively the right and left ear of the user. E.g. for five spatial channels a total of 5 HRTF pairs sets are included to produce the two channel spatial surround signal.

Thus, in the example, the MPEG Surround decoding unit 111 comprises a two stage process. First, an MPEG Surround decoder performs MPEG Surround compatible decoding to regenerate the encoded multi-channel signal. This decoded multi-channel signal is then fed to a binaural processor which applies the HRTF pairs to generate a binaural spatial signal (the binaural processing is not part of the MPEG Surround standard).

Thus, in the MPEG Surround system of FIG. 1, the synthesized signals are based on the assumed loudspeaker setup with one loudspeaker for each channel. The loudspeakers are assumed to be at nominal positions reflected in the HRTF functions. However, this approach tends to provide suboptimal performance and indeed the approach of effectively attempting to model the signal components reaching the user from each of the different loudspeaker positions results in a less well-defined position of sounds in the sound stage. For example, for a user to perceive a sound component at a specific position in the sound stage, the approach of FIG. 1 first calculates the contribution from this sound component to each of the loudspeakers and then the contribution from each of these loudspeaker positions to the signal reaching the listeners ears. Such an approach has been found to not only be resource demanding but also to lead to a perceived reduction in the audio quality and spatial experience.

It should also be noted that whereas the upmixing and HRTF processing may in some cases be combined into a single processing step, e.g. by applying a suitable single matrix representing the combined effect of the upmixing and the HRTF processing to the down-mix signal, such an approach still inherently reflects a system wherein an individual sound radiation (loudspeaker) for each channel is synthesized.

FIG. 2 illustrates an example of an audio synthesizer in accordance with some embodiments of the invention.

In the system, the downmix is decomposed into at least two signal components wherein one signal component corresponds to a main directional signal component and the other signal component corresponds to an indirect/decorrelated signal component. The direct component is then synthesized by simulating a virtual loudspeaker directly at the phantom position for this direct signal component. Furthermore, the phantom position is determined from the spatial parameters of the parametric extension data. Thus, the directional signal is directly synthesized to originate from one specific direction and accordingly only two HRTF functions are involved in the calculation of the combined signal component reaching the ears of the listener. Furthermore, the phantom position is not limited to any specific speaker positioning (such as between stereo speakers) but can be from any direction, including from the back of the listener. Also, the exact position of the phantom source is controlled by the parametric extension data and thus is generated to originate from the appropriate Surround source direction of the original input surround sound signal.

The indirect component is synthesized independently of the directional signal and is specifically synthesized such that it generally does not originate from the calculated phantom position. For example, it may be synthesized to originate from one or more fixed positions (e.g. to the back of the listener). Thus, the indirect/decorrelated signal component which corresponds to a diffuse or ambient sound component is generated to provide a diffuse spatial sound experience.

This approach overcomes some or all of the disadvantages associated with relying on a (virtual) loudspeaker setup and a sound source position for each surround sound channel. Specifically, it typically provides a more realistic virtual surround sound experience.

Thus, the system of FIG. 2 provides an improved MPEG Surround decoding approach comprising the following stages:

Signal decomposition of the downmix into a main and ambience component,

Directional analysis based on the MPEG Surround spatial parameters,

Binaural rendering of the main component with HRTF data derived from directional analysis, and

Binaural rendering of the ambience component with different HRTF data that may specifically correspond to a fixed position.

The system specifically operates in a sub-band domain or frequency domain. Thus, the downmix signal is transformed to a sub-band domain or frequency domain representation where the signal decomposition takes place. In parallel directional information is derived from the spatial parameters. The directional information, typically angular data with optionally distance information, may be adjusted, e.g. to include an offset induced by a head tracker device. The HRTF data corresponding to the resulting directional data is then used to render/synthesize the main and ambience components. The resulting signal is transformed back to the time domain resulting in the final output signal.

In more detail, the decoder of FIG. 2 receives a stereo down-mix signal comprising a left and right channel. The downmix signal is fed to a left and right domain transform processor 201, 203. Each of the domain transform processors 201, 203 convert the incoming downmix channel to the subband/frequency domain.

The domain transform processors 201, 203 generate a frequency domain representation wherein the downmix signal is divided into time-interval frequency-band blocks, henceforth referred to as time-frequency tiles. Each of the time-frequency tiles corresponds to a specific frequency interval in a specific time interval. For example, the downmix signal may be represented by time frames of e.g. 30 msec duration and the domain transform processors 201, 203 may perform a Fourier transform (e.g. a Fast Fourier Transform) in each time frame resulting in a given number of frequency bins. Each frequency bin in each frame may then correspond to a time-frequency tile. It will be appreciated that in some embodiments, each time-frequency tile may for example include a plurality of frequency bins and/or time frames. For example, frequency bins may be combined such that each time-frequency tile corresponds to a Bark band.

In many embodiments, each time-frequency tile will typically be less than 100 msec and 200 Hz or half the center frequency of the frequency tile.

In some embodiments, the decoder processing will be performed on the whole audio band. However, in the specific example, each time-interval frequency-band block will be processed individually. Accordingly, the following description focuses on an implementation wherein the decomposition, directional analysis and synthesis operations are applied individually and separately to each time-interval frequency-band block. Furthermore, in the example each time-interval frequency-band block corresponds to one time-frequency tile but it will be appreciated that in some embodiments a plurality of e.g. FFT bins or time frames may be grouped together to form a time-interval frequency-band block.

The domain transform processors 201, 203 are coupled to a signal decomposition processor 205 which is arranged to decompose the frequency domain representation of the downmix signal to generate at least a first and second signal component.

The first signal component is generated to correspond to a main directional signal component of the down-mix signal. Specifically, the first signal component is generated to be an estimate of the phantom source that would be obtained with an amplitude panning technique in a classical loudspeaker system. Indeed, the signal decomposition processor 205 seeks to determine the first signal component to correspond to the direct signal that would be received by a listener from a sound source represented by the downmix signal.

The second signal component is a signal component that is at least partially (and often substantially fully) decorrelated with the first signal component. Thus, the second signal component may represent a diffuse signal component for the downmix signal. Indeed, the signal decomposition processor 205 may seek to determine the second signal component to correspond to the diffuse or indirect signal that would be received by a listener from a sound source represented by the downmix signal. Thus, the second signal component may represent the non-directional components of the sound signal represented by the downmix signal, such as reverberations, room reflections etc. Hence, the second signal component may represent the ambient sound represented by the downmix signal.

In many embodiments, the second signal component may correspond to a residual signal that results from compensating the downmix for the first signal component. For example, for a stereo downmix, the first signal component may be generated as a weighted summation of the signal in the two channels with the restriction that the weights must be power neutral. For example:

x₁=a·l+b·r

where l and r are the downmix signal in the left and right channel respectively and a and b are weights that are selected to result in the maximum power of x₁ under the constraint:

\sqrt{a²+b²}=1

Thus, the first signal is generated as a function which combines the signals for a plurality of channels of the downmix. The function itself is dependent on two parameters that are selected to maximise the resulting power for the first signal component. In the example, the parameters are further constrained to result in the combination of the signals of the downmix to be power neutral, i.e. the parameters are selected such that variations in the parameters do not affect the achievable power.

The calculation of this first signal may allow a high probability that the resulting first signal component corresponds to the main directional signal that would reach a listener.

In the example, the second signal may then be calculated as a residual signal e.g. simply by subtracting the first signal from the downmix signal. For example, in some scenarios, two diffuse signals may be generated where one such diffuse signal corresponds to the left downmix signal from which the first signal component is subtracted and the other such diffuse signal corresponds to the right downmix signal from which the first signal component is subtracted.

It will be appreciated that different decomposition approaches can be used in different embodiments. For example, for a stereo downmix signal, the decomposition approaches applied to a stereo signal in European patent application EP 07117830.5 and “Phantom Materialization: A Novel Method to Enhance Stereo Audio Reproduction on Headphones” by J. Breebaart, E. Schuijers, IEEE Transactions on Audio, Speech, and Language Processing, Vol. 16, No. 8, pp. 1503-1511, November 2008 can be applied.

For example, a number of decomposition techniques may be suitable for decomposing a stereo downmix signal into one or more directional/main signal components and one or more ambience signal components.

For example, a stereo downmix may be decomposed into a single directional/main component and two ambience components according to:

$$[ \begin{matrix}m \\ {d}_{l} \\ {d}_{r}\end{matrix} ] = [ \begin{matrix}\frac{1}{sin γ + cos γ} & \frac{1}{sin γ + cos γ} \\ \frac{cos γ}{sin γ + cos γ} & \frac{- sin γ}{sin γ + cos γ} \\ \frac{- cos γ}{sin γ + cos γ} & \frac{sin γ}{sin γ + cos γ}\end{matrix} ] \cdot [ \begin{matrix}l \\ r\end{matrix} ] ,$$

where l represents the signal in the left downmix channel, r represents the signal in the right downmix channel, m represents the main signal component and dₗ and dᵣ represent diffuse signal components. γ is a parameter that is chosen such that the correlation between the main component m and the ambience signals (dₗ and dᵣ) becomes zero and such that the power of the main directional signal component m is maximized.

As another example, a rotation operation can be used to generate a single directional/main and a single ambience component:

$$[ \begin{matrix}m \\ d\end{matrix} ] = [ \begin{matrix}cos α & sin α \\ - sin α & cos α\end{matrix} ] \cdot [ \begin{matrix}l \\ r\end{matrix} ] ,$$

where the angle α is chosen such that the correlation between the main signal m and the ambience signal d becomes zero and the power of the main component m is maximized. It is noted that this example corresponds to the previous example of generating the signal components with the equivalence of a=sin(α) and b=sin(α). Furthermore, the calculation of the ambience signal d may be seen as a compensation of the downmix signal for the main component m.

As yet another example, the decomposition may generate two main and two ambience components from a stereo signal. First, the rotation operation described above may be used to generate a single directional/main component:

$$[ m ] = [ \begin{matrix}cos α & sin α\end{matrix} ] \cdot [ \begin{matrix}l \\ r\end{matrix} ] .$$

The left and right main components may then be estimated as the least-squares fit of the estimated mono signal:

$$[ \begin{matrix}{m}_{l} \\ {m}_{r}\end{matrix} ] = [ \begin{matrix}{a}_{l} \\ {a}_{r}\end{matrix} ] \cdot [ m ] , \\ where$$

$${a}_{l} = \frac{{\sum }_{k ∈ {k}_{tile}} m [ k ] \cdot {l}^{*} [ k ]}{{\sum }_{k ∈ {k}_{tile}} m [ k ] \cdot {m}^{*} [ k ]} , \\ {a}_{r} = \frac{{\sum }_{k ∈ {k}_{tile}} m [ k ] \cdot {r}^{*} [ k ]}{{\sum }_{k ∈ {k}_{tile}} m [ k ] \cdot {m}^{*} [ k ]} ,$$

where m[k], l[k] and r[k] represent the main, left and right frequency/subband domain samples corresponding to time-frequency tile kₜᵢₗₑ.

The two left and right ambience components dₗ and dᵣ are then calculated as:

dₗ=l−aₗ·m,

dᵣ=r−aᵣ·m.

In some embodiments, the downmix signal may be a mono signal. In such embodiments, the signal decomposition processor 205 may generate the first signal component to correspond to the mono signal whereas the second signal component is generated to correspond to a decorrelated signal for the mono-signal.

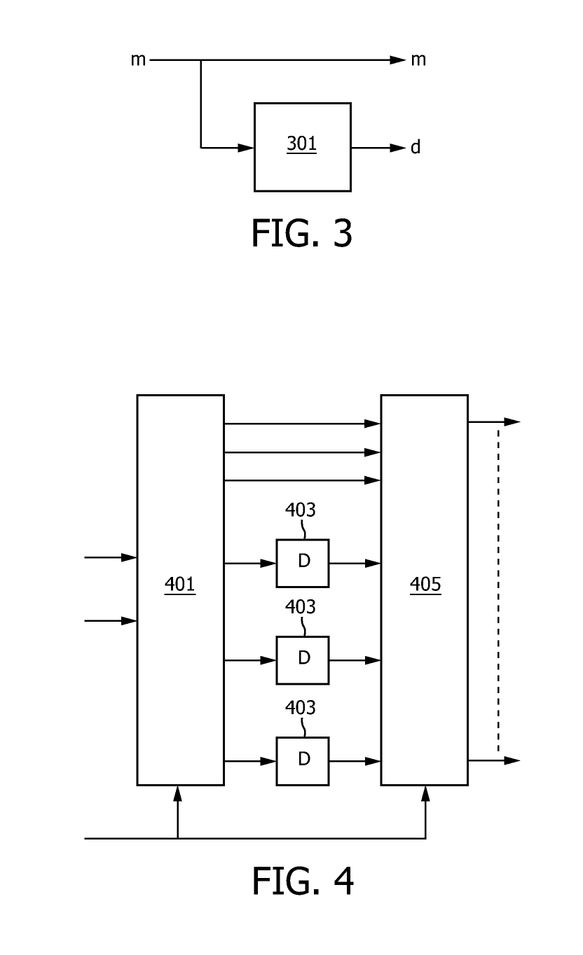

Specifically, as illustrated in FIG. 3, the downmix may directly be used as the main directional signal component whereas the ambience/diffuse signal component is generated by applying a decorrelation filter 301 to the downmix signal. The decorrelation filter 301 may for example be a suitable all-pass filter as will be known to the skilled person. The decorrelation filter 301 may specifically be equivalent to a decorrelation filter typically used for MPEG Surround decoding.

The decoder of FIG. 2 furthermore comprises a position processor 207 which receives the parametric extension data and which is arranged to determine a first spatial position indication for the first signal component in response to the parametric extension data. Thus, based on the spatial parameters, the position processor 207 calculates an estimated position for the phantom source that corresponds to the main directional signal components.

In some embodiments, the position processor 207 may also determine a second spatial position indication for the second signal component in response to the parametric extension data. Thus, based on the spatial parameters, the position processor 207 may in such embodiments calculate one or more estimated positions for the phantom source(s) that corresponds to the diffuse signal component(s).

In the example, the position processor 207 generates the estimated position by first determining upmix parameters for upmixing the downmix signal to an upmixed multi-channel signal. The upmix parameters may directly be the spatial parameters of the parametric extension data or may be derived therefrom. A speaker position is then assumed for each of the channels of the upmixed multichannel signal and the estimated position is calculated by combining the speaker positions dependent on the upmix parameters. Thus, if the upmix parameters indicate that the downmix signal will provide a strong contribution to a first channel and a low contribution to a second channel, then the speaker position for the first channel is weighted higher than the second channel.

In particular, the spatial parameters may describe a transformation from the downmix signal to the channels of the upmixed multi-channel signal. This transformation may for example be represented by a matrix which associates signals of the upmix channel with the signals for the downmix channels.

The position processor 207 may then determine an angular direction for the first spatial position indication by a weighted combination of the angles to each of the assumed speaker positions for each channel. The weight for a channel may specifically be calculated to reflect the gain (e.g. amplitude or gain) of the transformation from the down mix signal to that channel.

As a specific example, in some embodiments the directional analysis performed by the position processor 207 may be based on an assumption that the direction of the main signal component corresponds to the direction for the ‘dry’ signal parts of the MPEG Surround decoder; and that the direction of the ambience components corresponds to the direction of the ‘wet’ signal parts of the MPEG Surround decoder. In this context, the wet signal parts may be considered to correspond to the part of the MPEG surround upmix processing that includes a decorrelation filter and the dry signal parts may be considered to correspond to the part which does not include this.

FIG. 4 illustrates an example of an MPEG Surround upmix function. As illustrated the downmix is first upmixed to a first set if channels by a first matrix processor 401 which applies a first matrix operation.

Some of the generated signals are then fed to decorrelation filters 403 to generate decorrelated signals. The decorrelated output signals, together with the signals from the first matrix processor 401 that are not fed to a decorrelation filter 403, are then fed to a second matrix processor 405 which applies a second matrix operation. The output of the second matrix processor 405 is then the upmixed signal.

Thus, the dry parts may correspond to the part of the function of FIG. 6 that does not generate or process the input or output signals of the decorrelation filters 403.

Similarly, the wet parts may correspond to the part of the function of FIG. 6 that does generate or process the input or output signals of the decorrelation filters 403.

Thus, in the example, the downmix is first processed by a pre-matrix M₁ in the first matrix processor 401. The pre-matrix M₁ is a function of the MPEG Surround spatial parameters as will be known to the skilled person. Part of the output of the first matrix processor 401 is fed to a number of decorrelation filters 403. The output of the decorrelation filters 403 together with the remaining outputs of the pre-matrix is used as input for the second matrix processor 405 which applies a mix-matrix M₂ which is also a function of the MPEG Surround spatial parameters (as will be known to the skilled person).

Mathematically this process can be described for each time-frequency tile as:

v=M₁·x,

where x represents the downmix signal vector, M₁ represents the pre-matrix which is a function of the MPEG Surround parameters specific for the current time-frequency tile, and v is the intermediate signal vector consisting in a part v_{dir} that will be fed directly to the mix-matrix and a part v_{amb} that will be fed to the decorrelation filters:

$$v = [ \begin{matrix}{v}_{dir} \\ {v}_{amb}\end{matrix} ] = [ \begin{matrix}{M}_{1 , dir} \\ {M}_{1 , amb}\end{matrix} ] \cdot x .$$

The signal vector w after decorrelation filters 403 can be described as:

$$w = [ \begin{matrix}{v}_{dir} \\ D \{ {v}_{amb} \}\end{matrix} ] ,$$

where D{.} represents the decorrelation filters 403. The final output vector y is constructed from the mix-matrix as:

y=M₂·w,

where M₂=[M_{2,dir} M_{2,amb}] represents the mix-matrix, which is a function of the MPEG Surround parameters.

From the mathematical representation above it can be seen that the final output signal is a superposition of the dry signals and the wet (decorrelated) signals:

y=y_{dir}+y_{amb},

where:

y_{dir}=M_{2,dir}·v_{dir},

y_{amb}=M_{2,amb}·D{v_{amb}}.

Thus, the transformation from the downmix to the upmixed multi-channel surround signal can be considered to include first sub-transformation which includes a signal decorrelation function and a second sub-transformation which does not include a signal decorrelation function.

Specifically, for a mono downmix, the first sub-transformation may be determined as:

y_{dir}=M_{2,dir}·M_{1,dir}x=G_{dir}·x,

where x represents the mono downmix and G_{dir} represents the overall matrix, mapping the downmix to the output channels.

The direction (angle) of the corresponding virtual phantom sound source can then be derived e.g. as:

$${ψ}_{dir} = ∠ \{ {\sum }_{∀ ch} {\vert {G}_{dir , ch} \vert}^{2} \cdot exp ( j \cdot {ϕ}_{ch} ) \} ,$$

where φ represents the assumed angles associated with a loudspeaker setup.
For example

$$ϕ = \frac{2 π}{360} \cdot [ 30 , 30 , 0 , - 110 , 110 ] ,$$

for the left front, right front, center, left surround and right surround speakers respectively may often be appropriate.

It will be appreciated that in other embodiments, other weightings than |G_{dir,ch}|² may be employed and indeed that many other functions of the gains and presumed angles may be used depending on the preferences and requirements of the individual embodiments.

A problem with the previous calculation of the angle is that the different angles may in some scenarios tend to cancel each other out. For example, if |G_{dirr,ch}|² is approximately equal for all channels, a high sensitivity for the determined angle may occur.

In some embodiments, this may be mitigated by a calculation of the angles for all (adjacent) speaker pairs, such as e.g.:

$${ψ}_{dir , p} = ∠ \{ {\sum }_{∀ ch \vert {ϕ}_{ch} ∈ p} {\vert {G}_{dir , ch} \vert}^{2} \cdot exp ( j \cdot {ϕ}_{ch} ) \} ,$$

where p represents the speaker pairs

$$p ∈ \frac{2 π}{360} \cdot \{ ( - 110 , - 30 ) , ( - 30 , 0 ) , ( 0 , 30 ) , ( 30 , 110 ) , ( 110 , - 110 ) \} .$$

Thus, based on the sub-transformation

y_{dir}=M_{2,dir}·M_{1,dir}·x=G_{dir}·x,

the direction for the main directional signal, namely the first signal component can be estimated. The position (direction/angle) for the main directional signal component in a time-frequency tile is determined to correspond to the position that corresponds to the dry processing of the upmix characterized by the spatial parameters as well as the assumed speaker positions.

In a similar fashion, an angle can be derived for the ambience components (the second signal component) based on the sub-transformation given by:

y_{amb}=M_{2,amb}·M_{1,amb}·x=G_{amb}·x.

Thus, in the example, the position (direction/angle) for the diffuse signal component in a time-frequency tile is determined to correspond to the position that corresponds to the wet processing of the upmix characterized by the spatial parameters as well as the assumed speaker positions. This may provide an improved spatial experience in many embodiments.

In other embodiments, a fixed position or positions may be used for the diffuse signal component(s). Thus, the angle of the ambience components may be set to a fixed angle, e.g. at the positions of the surround speakers.

It will be appreciated that whereas the above example is based on the MPEG Surround upmixing characterized by the spatial parameters, no actual such upmixing of the downmix is performed by the position processor 207.

For a stereo downmix signal, two angles may for example be derived. This may correspond to the example where two main signal components are generated by the decomposition and indeed one angle may be calculated for each main signal.

Thus, the directional dry upmixing may correspond to:

$${y}_{dir} = {M}_{2 , dir} \cdot {M}_{1 , dir} \cdot [ \begin{matrix}l \\ r\end{matrix} ] = {G}_{dir} \cdot [ \begin{matrix}l \\ r\end{matrix} ] = [ \begin{matrix}{G}_{dir , l} & {G}_{dir , r}\end{matrix} ] \cdot [ \begin{matrix}l \\ r\end{matrix} ] ,$$

resulting in the two angles:

$${ψ}_{dir , l} = ∠ \{ {\sum }_{∀ ch} {\vert {G}_{dir , l , ch} \vert}^{2} \cdot exp ( j \cdot {ϕ}_{ch} ) \} , \\ {ψ}_{dir , r} = ∠ \{ {\sum }_{∀ ch} {\vert {G}_{dir , r , ch} \vert}^{2} \cdot exp ( j \cdot {ϕ}_{ch} ) \} .$$

The calculation of two such angles is particularly advantageous and suitable for a scenario where MPEG Surround is used together with a stereo downmix since MPEG surround typically does not include spatial parameters defining relations between the left and right downmix channels.

In a similar fashion, two ambience components may be derived ψ_{amb,l} and ψ_{amb,r}, one for the left downmix channel and one for the right downmix channel respectively.

In some embodiments, the position processor 207 may further determine a distance indication for the first signal component. This may allow the subsequent rendering to use HRTFs that reflect this distance and may accordingly lead to an improved spatial experience.

As an example, the distance may be estimated from:

$${D}_{dir} = \frac{\vert {\sum }_{∀ ch} {\vert {G}_{ch} \vert}^{2} \cdot exp ( j \cdot {ϕ}_{ch} ) \vert}{{\sum }_{∀ ch} {\vert {G}_{ch} \vert}^{2}} \cdot ( {d}_{max} - {d}_{min} ) + {d}_{min} ,$$

where dₘᵢₙ and dₘₐₓ represent a minimum and maximum distance, e.g. dₘᵢₙ=0.5m and dₘₐₓ=2.5m and D_{dir} represents the estimated distance of the virtual sound source position.

In the example, the position processor 207 is coupled to an optional adjustment processor 209 which may adjust the estimated position for the main directional signal component and/or for the diffuse signal components.

For example, the optional adjustment processor 209 may receive head tracking information and may adjust the position of the main sound sources accordingly. Alternative, the sound stage may be rotated by adding a fixed offset to the angles determined by the position processor 207.

The system of FIG. 2 further comprises a binaural processor 211 which is coupled to the optional adjustment processor 209 and the signal decomposition processor 205. The binaural processor 211 receives the first and signal components (i.e. the decomposed main directional signal component and the diffuse signal component) as well as the corresponding estimated positions from the optional adjustment processor 209.

It then proceeds to render the first and second signal components such that they appear to a listener to originate from the positions indicated by the estimated positions received from the optional adjustment processor 209.

In particular, the binaural processor 211 proceeds to retrieve the two HRTFs (one for each ear) that correspond to the position estimated for the first signal component. It then proceeds to apply these HRTFs to the first signal component. The HRTFs may for example be retrieved from a look-up table comprising the appropriate parameterised HRTF transfer functions for each time-frequency tile for each ear. The look-up table may for example comprise a whole set of HRTF values for a number of angles, such as e.g. for each 5° angle. The binaural processor 211 may then simply select the HRTF values for the angle that most closely corresponds to the estimated position. Alternatively the binaural processor 211 may employ interpolation between available HRTF values.

Similarly, the binaural processor 211 applies the HRTFs corresponding to the desired ambiance position to the second signal component. In some embodiments, this may correspond to a fixed position and thus the same HRTF may always be used for the second signal component. In other embodiments, the position for the ambiance signal may be estimated and the appropriate HRTF values may be retrieved from the look-up table.

The HRTF filtered signals for the left and right channels respectively are then combined to generate the binaural output signals. The binaural processor 211 is further coupled to a first output transform processor 213 which converts the frequency domain representation of the left binaural signal to a time domain representation, and a second output transform processor 215 which converts the frequency domain representation of the right binaural signal to a time domain representation. The time domain signals may then be output and for example fed to headphones worn by a listener.

The synthesis of the output binaural signal is specifically conducted in a time- and frequency-variant fashion by applying a single parameter value to each frequency tile wherein the parameter value represents the HRTF value for that frequency, tile and desired position (angle). Thus, the HRTF filtering may be achieved by a frequency domain multiplication using the same time-frequency tiles as the remaining processing thereby providing a highly efficient calculation.

Specifically, the approach of “Phantom Materialization: A Novel Method to Enhance Stereo Audio Reproduction on Headphones” by J. Breebaart, E. Schuijers, IEEE Transactions on Audio, Speech, and Language Processing, Vol. 16, No. 8, pp. 1503-1511, November 2008 may be used.

For example, for a given synthesis angle ψ (and optionally distance D), the following parametric HRTF data may be available for each time/frequency tile:

An (average) level parameter of the left-ear HRTF p_{l,ψ},

An (average) level parameter of the right-ear HRTF p_{r,ψ},

An average phase difference parameter between the left and right-ear HRTFs φ_{lr,ψ}.

The level parameters represent the spectral envelopes of the HRTFs, the phase difference parameter represents a stepwise constant approximation of the interaural time difference.

For a given time-frequency tile, with a given synthesis angle ψ_{dir} derived from the directional analysis described above, the output signal is constructed as:

l_{dir}=m·p_{l,ψ}_{_{dir}}·exp(−jφ_{lr,}_{_{ψdir}}/2),

r_{dir}=m·p_{r,ψ}_{_{dir}}·exp(−jφ_{lr,}_{_{ψdir}}/2),

where m represents the time-frequency tile data of the main/directional component and l_{dir} and r_{dir} represent the time-frequency tile data of the left and right main/directional output signals respectively.

Similarly the ambience component is synthesized according to:

l_{amb}=d·p_{l,}_{_{ψamb}}·exp(−jφ_{lr,}_{_{ψamb}}/2),

r_{amb}=d·p_{r,}_{_{ψamb}}·exp(−jφ_{lr,}_{_{ψamb}}/2),

where d represents the time-frequency tile data of the ambience component, l_{amb} and r_{amb} represent the time-frequency tile data of the left and right ambience output signals respectively and in this case the synthesis angle ψ_{amb} corresponds to the directional analysis for the ambience component.

The final output signal is constructed by adding the main and ambience output components. In the case multiple main and/or multiple ambience components are derived during the analysis stage these may be synthesized individually and summed to form the final output signal.

For the embodiment where angles are calculated per channel pair this can be expressed as:

$${l}_{dir} = m \cdot {\sum }_{∀ p} {\sum }_{ch ∈ p} {G}_{ch} \cdot {p}_{l , {ψ}_{dir , p}} \cdot exp ( - {jφ}_{lr , {ψ}_{dir , p}} / 2 ) , \\ {r}_{dir} = m \cdot {\sum }_{∀ p} {\sum }_{ch ∈ p} {G}_{ch} \cdot {p}_{r , {ψ}_{dor , p}} \cdot exp ( + {jφ}_{lr , {ψ}_{dir , p}} / 2 ) .$$

Similarly the ambience components are rendered to the angles ψ_{amb,p}.

The previous description has focussed an example where a multi-source signal corresponds to a multi-channel signal, i.e. where each signal source corresponds to a channel of a multi-channel signal.

However, the described principles and approaches may also be applied directly to sound objects. Thus, in some embodiments, each source of the multi-source signal may be a sound object.

In particular, the MPEG standardization body is currently in the process of standardizing a ‘Spatial Audio Object Coding’ (SAOC) solution. From a high level perspective, in SAOC, instead of channels, sound objects are efficiently coded. Whereas in MPEG Surround, each speaker channel can be considered to originate from a different mix of sound objects, in SAOC estimates of these individual sound objects are available at the decoder for interactive manipulation (e.g. individual instruments may be individually encoded). Similarly to MPEG Surround, SAOC also creates a mono or stereo downmix which is then optionally coded using a standard downmix coder, such as HE AAC. Spatial object parameters are then embedded in the ancillary data portion of the downmix coded bitstream to describe how the original spatial sound objects can be recreated from the downmix. At the decoder side, the user can further manipulate these parameters in order to control various features of the individual objects, such as position, amplification, equalization and even application of effects such as reverberation. Thus, the approach may allow the end user to e.g. control the individual spatial position of individual instruments represented by individual sound objects.

In the case of such spatial audio object coding, single source (mono) objects are readily available for individual rendering. However, for stereo objects (two related mono objects) and multi-channel background objects, the individual channels are conventionally rendered individually. However, in accordance with some embodiments, the described principles may be applied to such audio objects. In particular, the audio objects may be decomposed into a main directional signal component and a diffuse signal component which may be rendered individually and directly from the desired position thereby leading to an improved spatial experience.

It will be appreciated that in some embodiments, the described processing may be applied to the whole frequency band, i.e. the decomposition and/or position determination may be determined based on the whole frequency band and/or may be applied to the whole frequency band. This may for example be useful when the input signal comprises only one main sound component.

However, in most embodiments, the processing is applied individually in groups of time-frequency tiles. Specifically, the analysis and processing may be performed individually for each time-frequency tile. Thus, the decomposition may be performed for each time-frequency tile and the estimated position may be determined for each time-frequency tile. Furthermore, the binaural processing is performed for each time-frequency tile by applying the HRTF parameters corresponding to the positions determined for that time-frequency tile to the first and second signal component values calculated for that time-frequency tile.

This may result in a time and frequency variant processing wherein the positions, decompositions etc vary for different time-frequency tiles. This may in particular be advantageous for the most common situation where the input signal comprises a plurality of sound components corresponding to different directions etc. In such a case, the different components should ideally be rendered from different directions (as they correspond to sound sources at different positions). This may in most scenarios be automatically achieved by individual time-frequency tile processing as each time-frequency tile will typically contain one dominant sound component and the processing will be determined to suit the dominant sound component. Thus, the approach will result in an automated separation and individual processing of the different sound components.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for synthesizing a multi-sound source signal, the apparatus comprising:
a unit (201, 203) for receiving an encoded signal representing the multi-sound source signal, the encoded signal comprising a downmix signal for the multi-sound source signal and parametric extension data for expanding the downmix signal to the multi-sound source signal;
a decomposition unit (205) for performing a signal decomposition of the downmix signal to generate at least a first signal component and a second signal component, the second signal component being at least partially decorrelated with the first signal component;
a position unit (207) for determining a first spatial position indication for the first signal component in response to the parametric extension data;
a first synthesizing unit (211, 213, 215) for synthesizing the first signal component based on the first spatial position indication; and
a second synthesizing unit (211, 213, 215) for synthesizing the second signal component to originate from a different direction than the first signal component.

2. The apparatus of claim 1 further comprising a unit (201, 203) for dividing the downmix into time-interval frequency-band blocks and being arranged to process each time-interval frequency-band block individually.

3. The apparatus of claim 2 wherein the first synthesizing unit (211, 213) is arranged to apply a parametric Head Related Transfer Function to time-interval frequency-band blocks of the first signal component, the parametric Head Related Transfer Function corresponding to a position represented by the first spatial position indication and comprising a parameter value set for each time interval frequency band block.

4. The apparatus of claim 1 wherein the multi-sound source signal is a spatial multi-channel signal.

5. The apparatus of claim 4 wherein the position unit (207) is arranged to determine the first spatial position indication in response to assumed speakers positions for channels of the multi-channel signal and an upmix parameters of the parametric extension data, the upmix parameters being indicative of an upmix of the downmix to result in the multi-channel signal.

6. The apparatus of claim 4 wherein the parametric extension data describes a transformation from the downmix signal to the channels of the multi-channel signal and the position unit (207) is arranged to determine an angular direction for the first spatial position indication in response to a combination of weights and angles for the assumed speakers positions for channels of the multi-channel signal, each weight for a channel being dependent on a gain of the transformation from the down mix signal to the channel.

7. The apparatus of claim 6 wherein the transformation includes a first sub-transformation including a signal decorrelation function and a second sub-transformation not including a signal decorrelation function, and wherein the determination of the first spatial position indication does not consider the first sub-transformation.

8. The apparatus of claim 1 further comprising a second position unit (207) arranged to generate a second spatial position indication for the second signal component in response to the parametric extension data; and the second synthesizing unit (211, 213, 215) is arranged to synthesize the second signal component based on the second spatial position indication.

9. The apparatus of claim 1 wherein the downmix signal is a mono signal and the decomposition unit (205) is arranged to generate the first signal component to correspond to the mono signal and the second signal component to correspond to a decorrelated signal for the mono-signal.

10. The apparatus of claim 1 wherein the first signal component is a main directional signal component and the second signal component is a diffuse signal component for the down-mix signal.

11. The apparatus of claim 1 wherein the second signal component corresponds to a residual signal resulting from compensating the downmix for the first signal component.

12. The apparatus of claim 1 wherein the decomposition unit (205) is arranged to determine the first signal component in response to a function combining signals for a plurality of channels of the downmix, the function being dependent on at least one parameter and wherein the decomposition unit (205) is further arranged to determine the at least one parameter to maximise a power measure for the first signal component.

13. The apparatus of claim 1 wherein each source of the multi-source signal is a sound object.

14. The apparatus of claim 1 wherein the first spatial position indication includes a distance indication for the first signal component and the first synthesizing unit (211, 213, 215) is arranged to synthesize the first signal component in response to the distance indication.

15. A method of synthesizing a multi-sound source signal, the method comprising:
receiving an encoded signal representing the multi-sound source signal, the encoded signal comprising a downmix signal for the multi-sound source signal and parametric extension data for expanding the downmix signal to the multi-sound source signal;
performing a signal decomposition of the downmix signal to generate at least a first signal component and a second signal component, the second signal component being at least partially decorrelated with the first signal component;
determining a first spatial position indication for the first signal component in response to the parametric extension data;
synthesizing the first signal component based on the first spatial position indication; and
synthesizing the second signal component to originate from a different direction than the first signal component.
